(19) United States
(12) Patent Application Publication
(10) Pub. No.: US 2009/0297795 A1
(43) Pub. Date: Dec. 3, 2009

(54) Ink-Jet Printing Using Disazo Dyes

(76) Inventors: Clive Edwin Foster, Blackley (GB); Gavin Wright, Blackley (GB); Neil James Thompson, Blackley (GB); Rachel Anne James, Waverton (GB)

Correspondence Address: MORGAN LEWIS & BOCKIUS LLP, 1111 PENNSYLVANIA AVENUE NW, WASHINGTON, DC, 20004, US

(21) Appl. No.: 12/494,409

(22) Filed: Jun. 30, 2009

(30) Foreign Application Priority Data
Jan. 7, 2008 (GB) 0811922.4

(51) Int. Cl. B32B 3/10; C09B 33/02; C09D 11/02; B05D 5/06

(52) U.S. Cl. 428/195.1; 534/756; 106/31.48; 427/256

(57) ABSTRACT

A compound of Formula (1) and salts thereof:

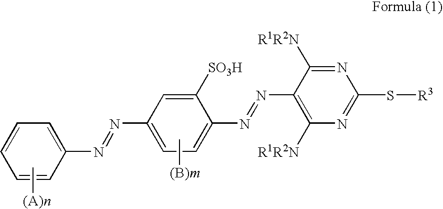

wherein:
A and B are each independently selected from the group consisting of —SO₃H, —CO₂H, —PO₃H₂, —NHCOR⁴, alkoxy;
R¹ and R² are each independently H or optionally substituted C₁₋₄alkyl;
R³ and R⁴ are each independently optionally substituted C₁₋₄alkyl;
m is 1 or 2; and
n is 1 to 3.

Also compositions, inks, printed material, ink-jet printing processes and ink-jet cartridges.

This invention relates to, ink-jet printing processes, compositions and inks, compounds, printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks. However as printer manufacturers strive for ever more realistic printed images ink-sets are being developed comprising additional coloured inks such as orange inks.

With the advent of high-resolution digital cameras and ink-jet printers it is becoming increasingly common for consumers to print off photographs using an ink-jet printer.

While ink-jet printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months with only intermittent use. Furthermore, and especially important with photographic quality reproductions, the resultant images should not bronze or fade rapidly on exposure to light or common oxidising gases such as ozone. It is also important that the shade and chroma of the colorant are exactly right so that any image may be optimally reproduced.

We have found that certain disazo 1,3-pyrimidine compounds provide orange colorants which are particularly suitable for use in ink-jet printing.

According to the present invention there is provided a compound of Formula (1) and salts thereof:

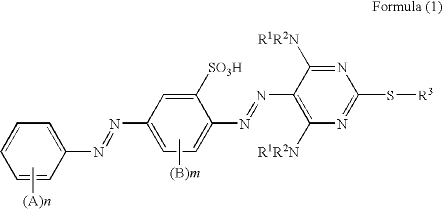

wherein:
A and B are each independently selected from the group consisting of —SO₃H, —CO₂H, —PO₃H₂, —NHCOR⁴ alkoxy;
R¹ and R² are each independently H or optionally substituted C₁₋₄alkyl;
R³ and R⁴ are each independently optionally substituted C₁₋₄alkyl;
m is 1 or 2; and
n is 1 to 3.

R¹ and R² are preferably independently H or unsubstituted C₁₋₄alkyl, more preferably R¹ and R² are independently H or methyl. It is especially preferred that R¹ and R² are H.

R³ and R⁴ are preferably independently unsubstituted C₁₋₄alkyl. It is especially preferred that R³ and R⁴ are methyl.

A is preferably —SO₃H.

B is preferably —SO₃H, —NHCOR⁴ (especially —NHCOCH₃) or alkoxy (especially methoxy).

n is preferably 1 or 2.

m is preferably 1.

Preferably at least one of the substituents represented by B is in the para position relative to the compulsory —SO₃H substituent on the middle phenyl ring.

Optional substituents which may be present on R¹, R², R³ and R⁴ when they are alkyl are independently selected from optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), —PO₃H₂, —CO₂H, nitro, —CN, halo, ureido, —SO₃H, —SO₂F, hydroxy, ester, —NR^{a}R^{b}, —COR^{a}, —CONR^{a}R^{b}, —NHCOR³, carboxyester, sulfone, and —SO₂NR^{a}R^{b}, wherein R^{a} and R^{b} are each independently H or optionally substituted alkyl (especially C₁₋₄-alkyl). Optional substituents for any of the substituents described above may be selected from the same list of substituents.

Preferred optional substituents independently present on R¹ and R² are selected from —OH—CO₂H, —SO₃H and —CN.

A particularly preferred compound of Formula (1) is of Formula (2) and salts thereof:

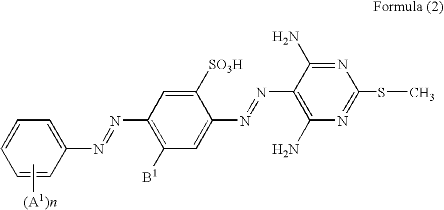

wherein:

A¹ is —SO₃H;

B¹ is —SO₃H, —NHCOCH₃ or methoxy; and

n is 1 or 2.

Compounds of Formula (1) are preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups preferably not present in the compounds of the first aspect of the present invention there may be mentioned aliphatic sulfonyl groups which contain a sulfate ester group in the beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring.

When compounds of Formula (1) or Formula (2) are in the form of a salt the preferred salts are alkali metal salts (especially lithium, sodium and potassium salts), ammonium and substituted ammonium salts and mixtures thereof. Especially preferred salts are sodium, potassium and lithium salts, salts with ammonia and volatile amines and mixtures thereof.

The compounds may be converted into a desired salt using known techniques. For example, an alkali metal salt of a compound may be converted into the ammonium or substituted ammonia salt by dissolving an alkali metal salt of the compound in water, acidifying with a mineral acid and adjusting the pH of the solution to pH 9 to 9.5 with ammonia or the amine and removing the alkali metal cations by dialysis or by use of an ion exchange resin.

Preferably the compounds of Formula (1) and Formula (2) have a solubility in water at 25° C. of at least 1%, more preferably of at least 2% and especially of at least 5%

The compounds of Formula (1) and Formula (2), as described herein, may exist in tautomeric forms other than those shown in this specification. These tautomers are also included within the scope of the present inventions.

The compounds of Formula (1) and Formula (2) have attractive, strong orange shades and are valuable colorants for use in the preparation of ink-jet printing inks. They benefit from a good balance of solubility, storage stability and fastness to water ozone and light. They are also useful in shading other coloured inks, especially black inks.

The compounds of Formula (1) may be prepared by diazotising a compound of Formula (3):

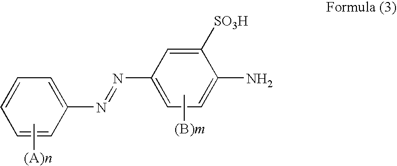

wherein A and B are as hereinbefore defined, to give a diazonium salt and coupling the resultant diazonium salt with a compound of Formula (4):

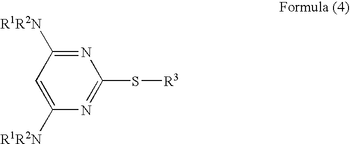

wherein R¹, R² and R³ are as hereinbefore defined.

The compounds of Formula (3) may be prepared by diazotising a compound of Formula (5):

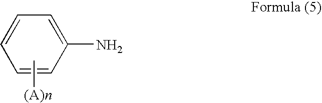

to give a diazonium salt and coupling the resultant diazonium salt with a compound of Formula (6):

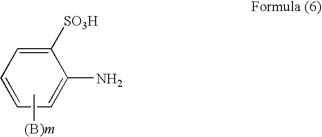

wherein A and B are as hereinbefore defined.

Compounds of Formulae (4), (5) and (6) are commercially available others may be prepared using synthetic protocols which would be well known to one of ordinary skill.

All diazotisation are preferably performed at a temperature of 0° C. to 10° C. Preferably diazotisations are performed in water, preferably at a pH below 7. Dilute mineral acid, e.g. HCL or H₂SO₄, may be used to achieve the desired pH conditions.

Reaction conditions are those generally used in the dyestuff art, for example as described in EP 0356080.

According to a second aspect of the present invention there is provided a composition comprising a compound of Formula (1) and/or a salt thereof, as described in the first aspect of the invention, and a liquid medium.

Preferred compositions according to the second aspect of the invention comprise:
(a) from 0.01 to 30 parts of a compound of Formula (1) and salts thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b).

Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include CO₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

It is preferred that the composition according to the invention is ink suitable for use in an ink-jet printer. Ink suitable for use in an ink-jet printer is ink which is able to repeatedly tire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

The ink suitable for use in an ink-jet printer is preferably either an orange ink or a black ink shaded with a compound of Formula (1) or a salt thereof, as described in the first aspect of the invention.

A third aspect of the invention provides a process for forming an image on a substrate comprising applying a composition, preferably ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred. Photographic quality papers are especially preferred. Photographic quality paper are high-gloss papers which give a similar finish to that typically seen with silver halide photo printing.

A fourth aspect of the present invention provides a material preferably paper, plastic, a textile, metal or glass, more preferably paper, an overhead projector slide or a textile material, especially paper more especially plain, coated or treated papers printed with a compound as described in the first aspect of the invention, a composition according to the second aspect of the invention or by means of a process according to the third aspect of the invention.

It is especially preferred that the printed material of the fourth aspect of the invention is a print on a photographic quality paper.

A fifth aspect of the present invention provides an ink-et printer cartridge comprising a chamber and a composition, preferably ink suitable for use in an ink-jet printer, wherein the composition is in the chamber and the composition is as defined and preferred in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated.

### EXAMPLE 1

### Preparation of

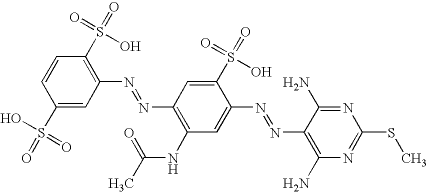

A cooled solution of 2-{(E)-[2-(acetylamino)-4-amino-5-sulfophenyl]diazenyl}-benzene-1,4-disulfonic acid (11.5 g, 11.3 mmol) in water (60 mL) at pH 7 (adjusted with saturated aqueous LiOH) was added drop-wise over 10 min to a cooled (<5° C.), stirred mixture of ice/water (50 mL) and c HCl (12 mL). The reaction mixture was stirred for 2 hours and excess nitrous acid was destroyed by the addition of sulfamic acid. A solution of 4,6-diamino-2-methylmercaptopyrimidine (1.76 g, 11.3 mmol) in water (40 mL) and c. HCl (10 mL) was added to the above mixture. The pH of the reaction mixture was adjusted to 4.5 (LiOAc) and pyridine (3 mL) was added. The reaction mixture was stirred overnight, during which time it was allowed to warm up to room temperature. The resultant solid was filtered off and dissolved in water (120 mL) at pH 7.5 (adjusted with saturated aqueous LiOH). The product was salted out (15% w/v LiCl) and filtered off. The solid was slurried in acetone (200 mL), filtered off and washed with acetone. The solid was dissolved in water (200 mL) and the solution was filtered (0.45 μm nylon), dialysed (<100 μScm⁻¹) and dried in an oven at 60° C.

### EXAMPLE 2

### Preparation of

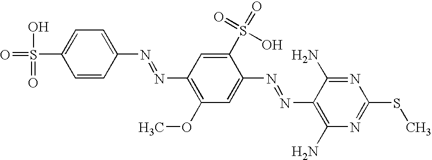

The compound of Example 2 was prepared by the process of Example 1 except that 2-{(E)-[2-(acetylamino)-4-amino-5-sulfophenyl]diazenyl}-benzene-1,4-disulfonic acid was replaced with 2-amino-4-methoxy-5-[(E)-(4-sulfophenyl)diazenyl]benzene sulfonic acid.

### COMPARATIVE EXAMPLE

The Comparative dye was prepared as described in Example 1 of International Patent Application WO2007/091006.

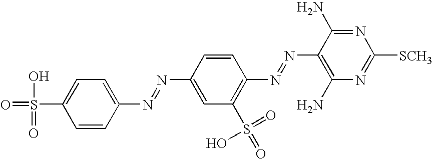

### EXAMPLE 3

### Preparation of the Example Ink and Comparative Ink

An Example Ink and a Comparative Ink were prepared by dissolving 3.5 g of the dye of Example 1 and the comparative dye in 96.5 g of a liquid medium comprising:

| | |
|---|---|
| Diethylene glycol | 7% |
| Ethylene glycol | 7% |
| 2-Pyrollidone | 7% |
| Surfynol ™ 465 | 1% |
| Tris buffer | 0.2% |
| Water | 77.8% (all % by weight) |

and adjusting the pH of the ink to 8-8.5 using sodium hydroxide.
Surfynol^{RTM} 465 is a surfactant from Air Products.

### EXAMPLE 4

### Ink-jet Printing

The Example Ink and Comparative Ink, prepared as described above, were filtered through a 0.45 micron nylon filter and then incorporated into empty print cartridges using a syringe.

These inks were then printed on to Canon Premium PR101 Photo Paper.

The prints so formed, at 50% depth, were tested for light fastness.

Light-fastness of the printed image was assessed by fading the printed image in an Atlas® Ci5000 Weatherometer for 100 hours and then measuring the change in the optical density.

Optical density measurements were performed using a Gretag® spectrolino spectrophotometer set to the following parameters:

| | |
|---|---|
| Measuring Geometry | 0°/45° |
| Spectral Range | 380-730 nm |
| Spectral Interval | 10 nm |
| Illuminant | D65 |
| Observer | 2° (CIE 1931) |
| Density | Ansi A |
| External Filler | None |

Light fastness may then be assessed by the percentage change in the optical density of the print, where a lower figure indicates higher fastness, and the degree of fade.

| Example | LF (ROD loss) |
|---|---|
| Example Ink | 4 |
| Comparative Ink | 7 |

From the above it may be seen that compounds of the present invention give prints with an improved light fastness.

### Further Inks

The inks described in Tables A and B may be prepared using the compound of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TDG=thiodiglycol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| | | | | | | | |
|---|---|---|---|---|---|---|---|
| Dye | Water | PG | DEG | NMP | TBT | BDL | PI2 |

| | | | | | | | |
|---|---|---|---|---|---|---|---|
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A compound of Formula (1) and salts thereof: 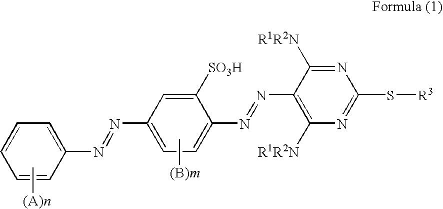
wherein:
A and B are each independently selected from the group consisting of —SO₃H, —CO₂H, —PO₃H₂, —NHCOR⁴, alkoxy;
R¹ and R² are each independently H or optionally substituted C₁₋₄alkyl;
R³ and R⁴ are each independently optionally substituted C₁₋₄alkyl;
m is 1 or 2; and
n is 1 to 3.

2. A compound of Formula (1) and salts thereof as claimed in claim 1 wherein R¹ and R² are H.

3. A compound of Formula (1) and salts thereof as claimed in claim 1 wherein R³ is methyl.

4. A compound of Formula (1) and salts thereof as claimed in claim 1 wherein R⁴ is methyl.

5. A compound of Formula (1) and salts thereof as claimed in claim 1 wherein A is —SO₃H.

6. A compound of Formula (1) and salts thereof as claimed in claim 1 wherein B is —SO₃H, —NHCOCH₃ or methoxy.

7. A compound of Formula (1) and salts thereof as claimed in claim 1 wherein n is 1 or 2.

8. A compound of Formula (1) and salts thereof as claimed in claim 1 wherein m is 1.

9. A compound of Formula (1) as claimed in claim 1 which is of Formula (2) and salts thereof: 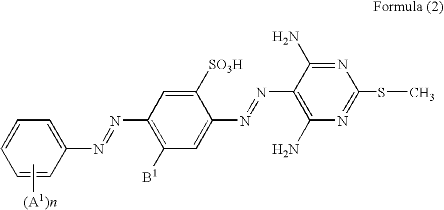
wherein:
A¹ is —SO₃H;
B¹ is —SO₃H, —NHCOCH₃ or methoxy; and
n is 1 or 2.

10. A composition comprising a compound of Formula (1) and/or a salt thereof, as claimed in claim 1 and a liquid medium.

11. A composition as claimed in claim 10 which is ink suitable for use in an ink-jet printer.

12. An ink suitable for use in an ink-jet printer as claimed in claim 11 which is a black ink shaded with a compound of Formula (1) or salt thereof as claimed in claim 1.

13. A process for forming an image on a substrate comprising applying ink suitable for use in an ink-jet printer, according to claim 12, thereto by means of an ink-jet printer.

14. A material printed with a compound as claimed in claim 1.

15. An ink-jet printer cartridge comprising a chamber and ink suitable for use in an ink-jet printer, according to claim 12, wherein the ink is in the chamber.
